(19) United States
(12) Patent Application Publication
(10) Pub. No.: US 2005/0179887 A1
(43) Pub. Date: Aug. 18, 2005

(54) Method of manufacturing an information recording medium and information recording medium manufacturing apparatus

(75) Inventors: Kazuki Suzawa, Tokyo (JP); Mamoru Usami, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/057,197

(22) Filed: Feb. 15, 2005

(30) Foreign Application Priority Data
Feb. 17, 2004 (JP) 2004-039353

(51) Int. Cl. G03B 27/72

(52) U.S. Cl. 355/100; 156/230

(57) ABSTRACT

A method of manufacturing and a manufacturing apparatus manufacture an information recording medium constructed so that a resin layer is formed so as to cover an information layer formed on one surface of an information recording medium substrate and recording data recorded on at least the information layer can be reproduced. The resin layer is formed, while a resin layer forming sheet that has an adhesive layer formed on one surface thereof is heated, by moving at least one out of the resin layer forming sheet and the information recording medium substrate toward another out of the resin layer forming sheet and the information recording medium substrate so that the information layer-side surface of the information recording medium substrate is pressed onto the adhesive layer to stick the information recording medium substrate and the resin layer forming sheet together.

### BACKGROUND OF THE INVENTION

1. Field of the Invention

The present invention relates to a method of manufacturing an information recording medium and an information recording medium manufacturing apparatus that manufacture an information recording medium (such as an optical disc) that has a resin layer formed on one surface of an information recording medium substrate.

2. Description of the Related Art

This type of method of manufacturing an information recording medium (optical disc) is disclosed by Japanese Laid-Open Patent Publication No. H10-208314. In this method of manufacturing, first, a tape, formed so that a pressure-sensitive adhesive sheet to be attached to a first disc substrate is stuck onto a lower surface of a backing tape (support member), is set between a supply roll and a winding roll. Next, a transfer robot conveys a first disc substrate from a disc store onto a stage of an index table. After this, an elastic body in an attaching apparatus applies pressure onto an upper surface of the pressure-sensitive adhesive sheet to press the sheet onto the first disc substrate on the stage. By doing so, the tape is stuck onto the upper surface of the first disc substrate. After this, the stage is lowered toward the index table and the index table is rotated so that the backing tape is peeled off the tape stuck on the first disc substrate. Next, after a second disc substrate has been placed on the pressure-sensitive adhesive sheet exposed by the removal of the backing tape, the second disc substrate is pressed onto the first disc substrate by an elastic body so that the two disc substrates are stuck together via the adhesive sheet. Next, both disc substrates are heated to around 60° C. and pressure is applied for around one minute to remove air (air bubbles) between the two disc substrates and the pressure-sensitive adhesive sheet. By doing so, an optical disc in which two disc substrates are stuck together via an adhesive layer formed between the disc substrates is manufactured.

By investigating the conventional method of manufacturing described above, the present inventors discovered the following problems. In the conventional method of manufacturing, air present between the disc substrates and the pressure-sensitive adhesive sheet is removed by heating and applying pressure after the two disc substrates are stuck together via the pressure-sensitive adhesive sheet. When the disc substrates are stuck together by the conventional method of manufacturing, there are cases where a large amount of air is trapped between the first disc substrate and the pressure-sensitive adhesive sheet when the tape (adhesive sheet) is stuck onto the first disc substrate and a large amount of air is trapped between the pressure-sensitive adhesive sheet and the second disc substrate when the second disc substrate is stuck onto the adhesive sheet on the first disc substrate. In such cases, since it is difficult to completely remove the air (air bubbles) trapped between the two disc substrates and the pressure-sensitive adhesive sheet by heating and applying pressure, there is the problem that air bubbles remain trapped inside the manufactured optical discs.

Also, in the conventional method of manufacturing, a tape (pressure-sensitive adhesive sheet) that has been wound around a supply roll is stuck onto the first disc substrate. Accordingly, in this conventional method of manufacturing where the pressure-sensitive adhesive sheet is left in a wound state until the sheet is stuck onto a disc substrate, tape with a curling tendency is stuck onto the disc substrate. In the conventional method of manufacturing, the tape is at normal temperature when the tape is stuck onto the disc substrate, and since the pressure-sensitive adhesive sheet is quite hard, when pressure is applied by the elastic body, it is difficult to correct the curling tendency mentioned above to make the tape flat. For this reason, in the conventional method of manufacturing, since the second disc substrate is stuck on in a state where a curling tendency (warping) is present in the pressure-sensitive adhesive sheet stuck on the first disc substrate, there is the problem that a slight warping can occur in the manufactured optical disc.

On the other hand, among current optical recording media, there are optical recording media where a light transmitting layer (resin layer) that can transmit a laser beam for recording and reproduction is formed so as to cover an information layer formed on a disc substrate. As a method of forming the light transmitting layer, a method has been proposed that sticks on a resin sheet (pressure-sensitive adhesive sheet) for forming the light transmitting layer onto a disc substrate that has an information layer formed on one surface. In this case, when the light transmitting layer has been formed by sticking a resin sheet for forming the light transmitting layer onto the disc substrate in accordance with the conventional method of manufacturing, as described above there are cases where air bubbles are produced between the disc substrate (information layer) and the light transmitting layer (resin sheet). For this reason, when a light transmitting layer has been formed on a disc substrate in accordance with the conventional method of manufacturing, the air bubbles trapped between the disc substrate and the light transmitting layer impede the transmission of a laser beam, so that there is the risk that it will be difficult to record and reproduce recording data properly.

### SUMMARY OF THE INVENTION

The present invention was conceived in view of the problems described above and it is a principal object of the present invention to provide a method of manufacturing an information recording medium and an information recording medium manufacturing apparatus that can form a resin layer without trapping air bubbles between an information recording medium substrate and the resin layer. It is a further object of the present invention to provide a method of manufacturing an information recording medium and an information recording medium manufacturing apparatus that can form a resin layer without causing a slight warping of the information recording medium.

A method of manufacturing an information recording medium according to the present invention manufactures an information recording medium constructed so that a resin layer is formed so as to cover an information layer formed on one surface of an information recording medium substrate and recording data recorded on at least the information layer can be reproduced, wherein the resin layer is formed, while a resin layer forming sheet that has an adhesive layer formed on one surface thereof is heated, by moving at least one out of the resin layer forming sheet and the information recording medium substrate toward another out of the resin layer forming sheet and the information recording medium substrate so that the one surface of the information recording medium substrate is pressed onto the adhesive layer to stick the information recording medium substrate and the resin layer forming sheet together.

An information recording medium manufacturing apparatus according to the present invention is capable of manufacturing an information recording medium in accordance with the method of manufacturing an information recording medium described above, the information recording medium manufacturing apparatus including: a heating device that heats the resin layer forming sheet; a moving mechanism that moves at least one out of the resin layer forming sheet and the information recording medium substrate toward the another out of the resin layer forming sheet and the information recording medium substrate; and a control unit that controls the heating device and the moving mechanism, wherein the control unit controls the heating device to heat the resin layer forming sheet and controls the moving mechanism to move at least one out of the resin layer forming sheet and the information recording medium substrate toward the another out of the resin layer forming sheet and the information recording medium substrate and to press the one surface of the information recording medium substrate onto the adhesive layer so as to stick the information recording medium substrate and the resin layer forming sheet together and form the resin layer.

According to the above method of manufacturing an information recording medium and information recording medium manufacturing apparatus, the resin layer is formed, while the resin layer forming sheet is heated, by moving at least one out of the resin layer forming sheet and the information recording medium substrate toward another out of the resin layer forming sheet and the information recording medium substrate to press one surface of the information recording medium substrate onto the adhesive layer and stick the information recording medium substrate and the resin layer forming sheet together. By doing so, the information recording medium substrate can be stuck on in a state where the adhesive layer has been softened by heating. Accordingly, since air (air bubbles) that could be trapped between the information recording medium substrate and the adhesive layer can be easily and reliably removed, the resin layer can be formed without trapping air bubbles between the information recording medium substrate and the adhesive layer. As a result, an information recording medium that is not susceptible to recording and reproduction errors can be manufactured. Also, since the resin layer forming sheet is heated and softens during the process that sticks the information recording medium substrate and the resin layer forming sheet together, even if the resin layer forming sheet is slightly bent, such bending can be easily and reliably corrected. Accordingly, it is possible to manufacture a flat information recording medium with no warping.

In this case, in a state where the resin layer forming sheet is heated having been mounted on a mounting table formed with a flat upper surface and the information recording medium substrate is bent so that a center part thereof projects toward the resin layer forming sheet, it is possible to move at least one out of the resin layer forming sheet and the information recording medium substrate toward the another out of the resin layer forming sheet and the information recording medium substrate to stick the information recording medium substrate and the resin layer forming sheet together by gradually placing the information recording medium substrate and the resin layer forming sheet in tight contact from central parts to outer edge parts thereof. By doing so, it is possible to efficiently remove air bubbles that could be trapped between the information recording medium substrate and the adhesive layer, so that it is possible to reliably avoid the situation where air bubbles are trapped between the information recording medium substrate and the adhesive layer (resin layer).

It is also possible to use a resin layer forming sheet where the adhesive layer is tightly attached to a support formed so as to be capable of being folded back in a zigzag state, and to detach the support from the adhesive layer when the resin layer forming sheet and the information recording medium substrate are stuck together. By doing so, unlike a method of manufacturing where a resin layer forming sheet that has been wound in a roll is stuck on, a curling tendency is not created in the resin layer forming sheet, so that a flat information recording medium with no warping can be manufactured.

It should be noted that the disclosure of the present invention relates to a content of Japanese Patent Application 2004-039353 that was filed on 17 Feb. 2004 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of a manufacturing apparatus;

FIG. 2 is a cross-sectional view of an optical recording medium manufactured by the manufacturing apparatus;

FIG. 3 is a cross-sectional view of a light transmitting resin sheet for manufacturing an optical recording medium;

FIG. 4 is an external perspective view of the light transmitting resin sheet;

FIG. 5 is a block diagram showing the construction of a sheet attaching device;

FIG. 6 is a cross-sectional view of a state where a mount is detached by a sheet conveying device;

FIG. 7 is a cross-sectional view of a state where a disc substrate has been positioned above a light transmitting resin sheet by the sheet attaching device;

FIG. 8 is a cross-sectional view of a state where a central part of a disc substrate has been brought into contact with a central part of an attached region of the light transmitting resin sheet by the sheet attaching device;

FIG. 9 is a cross-sectional view of a state where the entire disc substrate has been placed in tight contact with an attached region of the light transmitting resin sheet by the sheet attaching device; and

FIG. 10 is a cross-sectional view of a state where UV rays are irradiated by a UV irradiating device.

### DESCRIPTION OF THE PREFERRED EMBODIMENTS

Preferred embodiments of a method of manufacturing an information recording medium and an information recording medium manufacturing apparatus will now be described with reference to the attached drawings.

First, the construction of an optical recording medium manufacturing apparatus (one example of an information recording medium manufacturing apparatus according to the present invention, hereinafter simply “manufacturing apparatus”) 1 that manufactures an information recording medium in accordance with the method of manufacturing an information recording medium according to the present invention and the construction of an optical recording medium 100 manufactured by the manufacturing apparatus 1 will be described with reference to the drawings.

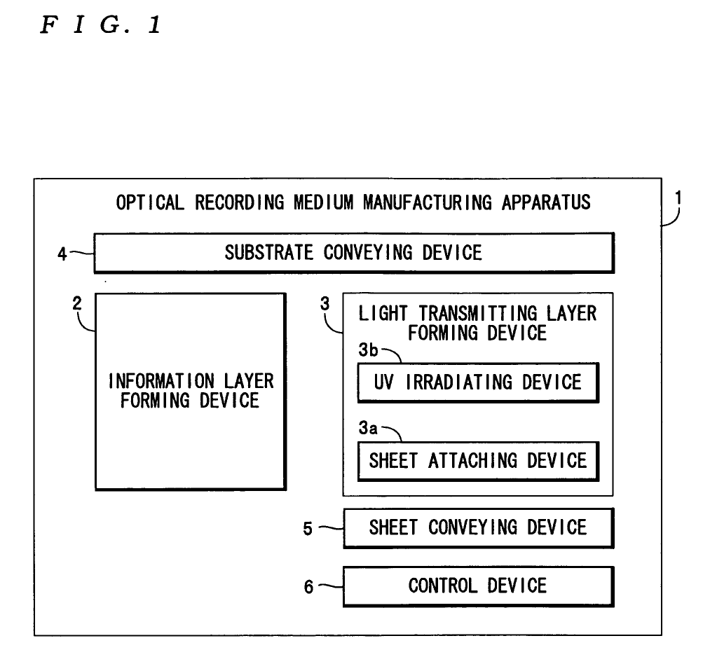

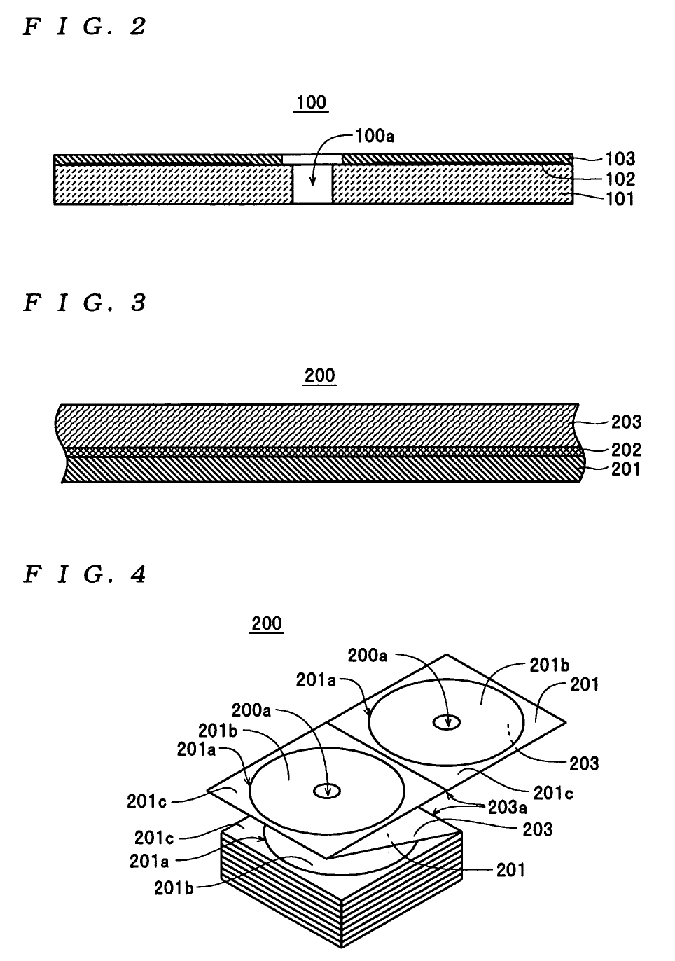

The manufacturing apparatus 1 shown in FIG. 1 is an apparatus that manufactures the optical recording medium 100 (one example of an “information recording medium” for the present invention) shown in FIG. 2 in accordance with the method of manufacturing an information recording medium according to the present invention, and includes an information layer forming device 2, a light transmitting layer forming device 3, a substrate conveying device 4, a sheet conveying device 5, and a control device 6. Here, as one example, the optical recording medium 100 is a write-once optical disc on which recording data can be recorded and reproduced, and as shown in FIG. 2, a light transmitting layer 103 is formed so as to cover an information layer 102 formed on one surface (the upper surface in FIG. 2) of a disc substrate 101. The disc substrate 101 is formed by injection molding using a resin material such as polycarbonate and is formed in a disc shape with a diameter of around 120 mm. An attachment center hole 100a with a diameter of around 15 mm is formed in the center of the disc substrate 101 for attachment to a recording/reproduction apparatus. The information layer 102 is formed by laminating functional layers such as a reflective layer and a recording layer. The light transmitting layer 103 is one example of a “resin layer” for the present invention, and in addition to transmitting a laser beam for recording and reproducing recording data on the information layer 102, prevents damage to, oxidization, and thermal deformation of the information layer 102. The light transmitting layer 103 is formed by sticking on a light transmitting resin sheet 200 shown in FIG. 3 so as to cover the information layer 102.

In this case, the light transmitting resin sheet 200 is one example of a “resin layer forming sheet” for the present invention, and as shown in FIG. 3, is constructed by applying an adhesive layer 202 composed of UV-curing resin or the like on one surface (the upper surface in FIG. 3) of a sheet member 201 that is around 100 μm thick and also sticking on a mount 203 (one example of a “support” for the present invention). As shown in FIG. 4, the light transmitting resin sheet 200 is formed so as to be capable of being folded back on itself in a zigzag state by folding the mount 203 along perforations 203a. The construction therefore differs to the case where the light transmitting resin sheet 200 is wound in a roll, and the creation of a curling tendency in the sheet member 201 is avoided. Here, circular cuts 201a with a diameter of around 120 mm that is equal to the diameter of the disc substrate 101 are formed in the sheet member 201 so as to separate attached regions 201b, which are to be attached to the disc substrates 101, and margin regions 201c. In addition, center holes 200a that have a slightly larger diameter (as one example, a diameter of 16 mm) than the attachment center holes 100a of the disc substrates 101 are formed by punching out the respective centers of the attached regions 201b so as to pass through the sheet member 201, the adhesive layer 202, and the mount 203.

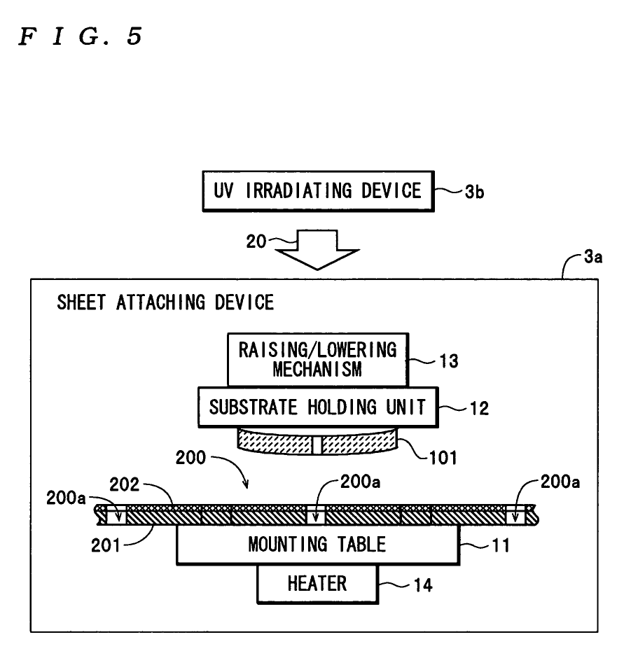

On the other hand, the information layer forming device 2 forms the information layer 102 by forming functional layers, such as a reflective layer and a recording layer, by sputtering, for example, various optical materials onto the surface of the disc substrate 101. For ease of explanation of the present invention, the construction and method of forming the respective thin films composing the information layer 102 will not be described. As shown in FIG. 1, the light transmitting layer forming device 3 includes a sheet attaching device 3a that sticks the light transmitting resin sheet 200 onto a disc substrate 101 on which the information layer 102 has been formed and a UV irradiating device 3b that hardens the adhesive layer 202 by irradiating UV rays 20 (see FIG. 5) onto the light transmitting resin sheet 200 that has been stuck on by the sheet attaching device 3a. As shown in FIG. 5, the sheet attaching device 3a includes a mounting table 11, a substrate holding unit 12, a raising/lowering mechanism 13 and a heater 14. The mounting table 11 is formed so that an upper surface thereof is flat so that the light transmitting resin sheet 200 conveyed by the sheet conveying device 5 can be mounted thereupon. As described later, the mounting table 11 heats the light transmitting resin sheet 200 mounted thereupon to around 60° C., for example, by being heated with the heater 14.

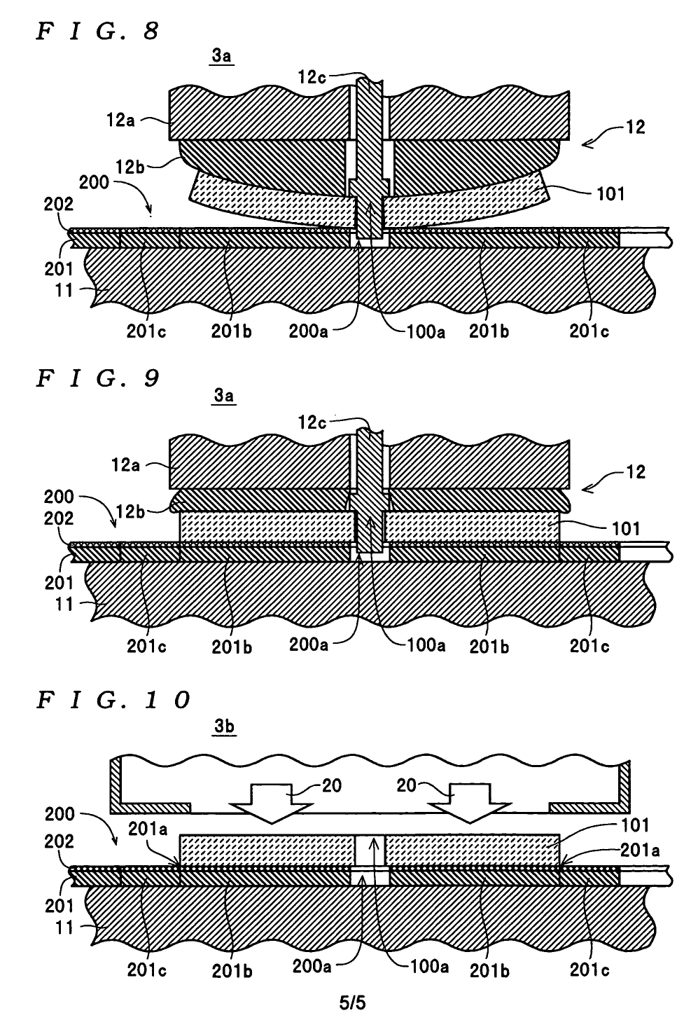

As shown in FIG. 7, the substrate holding unit 12 includes a base part 12a that is attached to the raising/lowering mechanism 13, a pad 12b that is attached to a lower surface of the base part 12a and causes the disc substrate 101 to bend, and a center pin 12c that is inserted through the attachment center hole 100a of the disc substrate 101. The pad 12b is formed of a open cell foam resin (elastic resin), for example, and by removing the air between the disc substrate 101 and the pad 12b using an air pump, not shown, the surface of the disc substrate 101 is attached by suction so that the disc substrate 101 is held. The tip of the center pin 12c is inserted through the attachment center hole 100a so as to position the disc substrate 101 on the substrate holding unit 12. Via a flange formed in a central part in the longitudinal direction thereof, the center pin 12c presses down an edge part of the attachment center hole 100a of the disc substrate 101 to cause the disc substrate 101 to bend with the central part of the disc substrate 101 projecting outward toward the mounting table 11 (i.e., toward the light transmitting resin sheet 200 on the mounting table 11). It should be noted that for ease of understanding the present invention, in FIG. 7 and in FIG. 8 that is referred to later, the bent state of the disc substrate 101 is illustrated with the bending having been exaggerated.

In accordance with control by the control device 6, the raising/lowering mechanism 13 moves (lowers) the substrate holding unit 12 toward the light transmitting resin sheet 200 on the mounting table 11 so that the surface (the lower surface in FIG. 7, which is the surface on which the information layer 102 has been formed) of the disc substrate 101 held by the substrate holding unit 12 is pressed onto the adhesive layer 202 of the light transmitting resin sheet 200, resulting in the disc substrate 101 and the light transmitting resin sheet 200 (the sheet member 201) becoming stuck together. The heater 14 corresponds to a “heating device” for the present invention and, under the control of the control device 6, heats the light transmitting resin sheet 200 via the mounting table 11. It should be noted that although a construction is used where the light transmitting resin sheet 200 is heated by heating the mounting table 11 with the heater 14, the present invention is not limited to this, and as one example, it is also possible to heat the light transmitting resin sheet 200 by constructing the heating device for the present invention with an IR emitting device that emits IR onto the light transmitting resin sheet 200 on the mounting table 11.

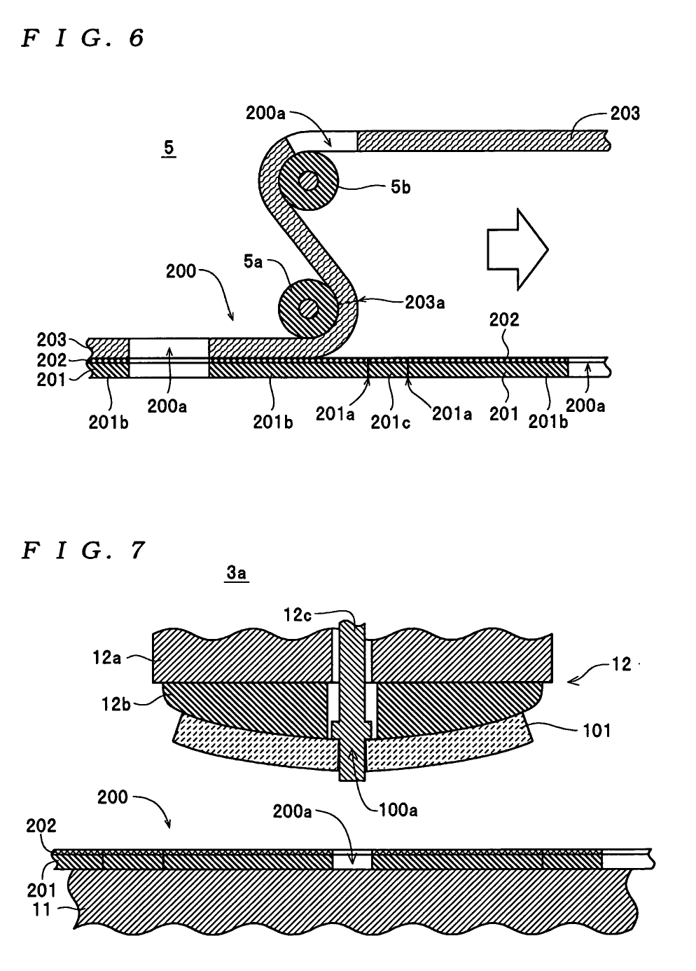

Under the control of the control device 6, the substrate conveying device 4 conveys a disc substrate 101 between the respective devices. The sheet conveying device 5 conveys the light transmitting resin sheet 200 that has been folded in a zigzag state onto the mounting table 11 of the sheet attaching device 3a. Also, as shown in FIG. 6, the sheet conveying device 5 includes rollers 5a and 5b for detaching the mount 203 from the adhesive layer 202 and immediately before the light transmitting resin sheet 200 is mounted on the mounting table 11, the sheet conveying device 5 bends the mount 203 to detach the mount 203 from the adhesive layer 202 while keeping the sheet member 201 flat. The control device 6 carries out overall control of the manufacturing apparatus 1. As described later, the control device 6 controls the sheet attaching device 3a to have the disc substrate 101 and the light transmitting resin sheet 200 stuck together, and controls the UV irradiating device 3b to irradiate the UV rays 20, so that the adhesive layer 202 is hardened, resulting in the sheet member 201 being attached to the disc substrate 101 to form the light transmitting layer 103.

Next, the method of manufacturing the optical recording medium 100 using the manufacturing apparatus 1 will be described with reference to the drawings.

First, the control device 6 controls the information layer forming device 2 to have the information layer 102 formed on the disc substrate 101. After this, the control device 6 controls the sheet conveying device 5 to have the light transmitting resin sheet 200 conveyed to the position of the substrate holding unit 12. At this time, as shown in FIG. 6, the sheet conveying device 5 keeps the sheet member 201 and the adhesive layer 202 flat while detaching the mount 203 from the adhesive layer 202 by passing the mount 203 over the rollers 5a and 5b. The sheet conveying device 5 conveys the sheet member 201 from which the mount 203 has been detached (both the attached regions 201b and the margin regions 201c: hereinafter the sheet member 201 and the adhesive layer 202 from which the mount 203 has been detached are also referred to as the “light transmitting resin sheet 200”) onto the mounting table 11 of the sheet attaching device 3a. It should be noted that the light transmitting resin sheet 200 conveyed by the sheet conveying device 5 is mounted on the mounting table 11 with the surface on which the adhesive layer 202 is formed facing upward. Next, the control device 6 controls the heater 14 to heat the mounting table 11 so that the light transmitting resin sheet 200 on the mounting table 11 is heated to around 60° C., for example. Here, since the sheet member 201 is heated and softens, even if the sheet member 201 is slightly bent, such bending is corrected and the sheet member 201 will become flat along the upper surface of the mounting table 11.

Next, the control device 6 controls the substrate conveying device 4 to have the disc substrate 101, for which the formation of the information layer 102 has been completed, conveyed to the substrate holding unit 12 in the sheet attaching device 3a. It should be noted that the disc substrate 101 conveyed by the substrate conveying device 4 is held by the substrate holding unit 12 with the surface on which the information layer 102 is formed facing downward. Here, as shown in FIG. 7, the substrate holding unit 12 holds the disc substrate 101 so that the central part thereof is projected downward by the center pin 12c (i.e., the central part is projected toward the adhesive layer 202). Next, the control device 6 controls the raising/lowering mechanism 13 to lower the substrate holding unit 12 so that the disc substrate 101 is pressed onto the light transmitting resin sheet 200 on the mounting table 11. Here, since the disc substrate 101 is held by the substrate holding unit 12 so that the central part is projected toward the mounting table 11 (i.e., toward the light transmitting resin sheet 200), as shown in FIG. 8, first, the central part of the disc substrate 101 (i.e., the edge part of the attachment center hole 100a) is placed in contact with the central part of an attached region 201b of the light transmitting resin sheet 200.

Next, when the substrate holding unit 12 is lowered further by the raising/lowering mechanism 13, the center pin 12c slides toward the base part 12a and the pad 12b elastically deforms so that the disc substrate 101 is gradually pressed onto the light transmitting resin sheet 200 from the central part to an outer edge part. At this time, since the light transmitting resin sheet 200 is heated by the heater 14 via the mounting table 11, air is smoothly expelled without being trapped between the disc substrate 101 and the adhesive layer 202. As a result, as shown in FIG. 9, the entire disc substrate 101 is pressed onto the attached region 201b of the light transmitting resin sheet 200 without air bubbles being trapped between the disc substrate 101 and the adhesive layer 202. At this point, the state where the disc substrate 101 is pressed onto the light transmitting resin sheet 200 is maintained for around one minute, for example. At this time, since the adhesive layer 202 is heated together with the sheet member 201 and softens, even if extremely small air bubbles are produced between the disc substrate 101 and the adhesive layer 202, such bubbles can be pressed out and expelled from between the disc substrate 101 and the adhesive layer 202 and the adhesive layer 202 can be tightly attached to the lower surface of the disc substrate 101.

Next, the control device 6 stops the air pump (not shown) and releases the holding of the disc substrate 101 by the substrate holding unit 12, then, the control device 6 controls the raising/lowering mechanism 13 to withdraw (raise) the substrate holding unit 12 from above the disc substrate 101. Next, as shown in FIG. 10, the control device 6 controls a moving mechanism (not shown) to have the UV irradiating device 3b move above the disc substrate 101 and controls the UV irradiating device 3b to have the UV rays 20 irradiated toward the disc substrate 101. At this time, the adhesive layer 202 hardens due to the light transmitting resin sheet 200 being irradiated with the UV rays 20 that have passed the disc substrate 101. By doing so, the disc substrate 101 and the sheet member 201 are attached by the hardened adhesive layer 202, thereby forming the light transmitting layer 103 on one surface of the disc substrate 101. After this, the control device 6 controls the moving mechanism (not shown) to have the disc substrate 101, on which the formation of the light transmitting layer 103 has been completed, raised above the mounting table 11. At this time, the attached region 201b moves together with the disc substrate 101 and is separated from the margin region 201c along the cut 201a in the sheet member 201. In this way, the manufacturing of the optical recording medium 100 shown in FIG. 2 is completed.

According to the method of manufacturing the optical recording medium 100 and the manufacturing apparatus 1, while the light transmitting resin sheet 200 is heated, the disc substrate 101 is moved toward the light transmitting resin sheet 200 and one surface of the disc substrate 101 is pressed onto the adhesive layer 202 to stick the disc substrate 101 and the light transmitting resin sheet 200 together and thereby form the light transmitting layer 103, so that the disc substrate 101 is stuck on in a state where the adhesive layer 202 has been softened by heating. Accordingly, it is possible to easily and reliably remove the air (air bubbles) that could be trapped between the disc substrate 101 and the adhesive layer 202, so that the light transmitting layer 103 can be formed without air bubbles being trapped between the disc substrate 101 and the adhesive layer 202. As a result, it is possible to manufacture an optical recording medium 100 that is not susceptible to recording and reproduction errors. Also, during the process that sticks together the disc substrate 101 and the light transmitting resin sheet 200, the sheet member 201 is heated and softens, so that even if the sheet member 201 was slightly bent, such bending can be reliably and easily corrected. Accordingly, a flat optical recording medium 100 with no warping can be manufactured.

According to the method of manufacturing the optical recording medium 100 and the manufacturing apparatus 1, in a state where the light transmitting resin sheet 200 is being heated after being mounted on the mounting table 11 that is formed with a flat upper surface and the disc substrate 101 is bent so that the central part thereof projects toward the light transmitting resin sheet 200, the disc substrate 101 and the light transmitting resin sheet 200 are gradually placed in tight contact and stuck together from the central parts thereof toward the outer edge parts, so that air bubbles that could be trapped between the disc substrate 101 and the adhesive layer 202 are efficiently removed. This means that the trapping of air bubbles between the disc substrate 101 and the adhesive layer 202 (the light transmitting layer 103) can be reliably avoided.

In addition, according to the method of manufacturing the optical recording medium 100 and the manufacturing apparatus 1, the light transmitting layer 103 is formed using the light transmitting resin sheet 200 where the adhesive layer 202 is tightly attached to the mount 203 that is formed so as to be capable of being folded back in a zigzag state, so that unlike a method of manufacturing that sticks on a light transmitting resin sheet 200 wound in a roll, the creation of a curling tendency in the sheet member 201 is avoided and flat optical recording media 100 with no warping can be manufactured.

It should be noted that the method of manufacturing an information recording medium and the manufacturing apparatus 1 according to the present invention are not limited to the method and constructions described above. For example, although an example has been described where the substrate holding unit 12 (the disc substrate 101) is moved toward the mounting table 11 (the light transmitting resin sheet 200) by the raising/lowering mechanism 13 when the disc substrate 101 and the light transmitting resin sheet 200 are stuck together by the sheet attaching device 3a, it is also possible to use a method where the light transmitting resin sheet 200 is moved toward and stuck onto the disc substrate 101 that is fixed at a predetermined position or a method where the disc substrate 101 and the adhesive layer 202 are both moved so as to approach one another and become stuck together. Also, although an example has been described where the light transmitting resin sheet 200 is stuck onto the disc substrate 101 in which the attachment center hole 100a has been formed, it is also possible to stick a light transmitting resin sheet 200 with no hole onto a disc substrate 101 in which the attachment center hole 100a has not been formed and to then form the attachment center hole 100a so as to pass through both the disc substrate 101 and the light transmitting resin sheet 200.

In addition, although an example has been described where a disc substrate 101 and a light transmitting resin sheet 200 with an adhesive layer 202 composed of a UV-curing resin are stuck together, the present invention is not limited to this, and it is possible to use a light transmitting resin sheet with an adhesive layer of electron-beam hardening resin that hardens when irradiated with various types of electron beam aside from UV rays or a light transmitting resin sheet with an adhesive layer composed of a pressure-sensitive adhesive.

1. A method of manufacturing an information recording medium constructed so that a resin layer is formed so as to cover an information layer formed on one surface of an information recording medium substrate and recording data recorded on at least the information layer can be reproduced,
wherein the resin layer is formed, while a resin layer forming sheet that has an adhesive layer formed on one surface thereof is heated, by moving at least one out of the resin layer forming sheet and the information recording medium substrate toward another out of the resin layer forming sheet and the information recording medium substrate so that the one surface of the information recording medium substrate is pressed onto the adhesive layer to stick the information recording medium substrate and the resin layer forming sheet together.

2. A method of manufacturing an information recording medium according to claim 1,
wherein in a state where the resin layer forming sheet is being heated having been mounted on a mounting table formed with a flat upper surface and the information recording medium substrate is bent so that a center part thereof projects toward the resin layer forming sheet, at least one out of the resin layer forming sheet and the information recording medium substrate is moved toward the another out of the resin layer forming sheet and the information recording medium substrate to stick the information recording medium substrate and the resin layer forming sheet together by gradually placing the information recording medium substrate and the resin layer forming sheet in tight contact from central parts to outer edge parts thereof.

3. A method of manufacturing an information recording medium according to claim 1,
wherein the resin layer forming sheet is constructed with the adhesive layer being tightly attached to a support that is formed so as to be capable of being folded back in a zigzag and the support is detached from the adhesive layer when the resin layer forming sheet and the information recording medium substrate are stuck together.

4. A method of manufacturing an information recording medium according to claim 2,
wherein the resin layer forming sheet is constructed with the adhesive layer being tightly attached to a support that is formed so as to be capable of being folded back in a zigzag and the support is detached from the adhesive layer when the resin layer forming sheet and the information recording medium substrate are stuck together.

5. An information recording medium manufacturing apparatus that is capable of manufacturing an information recording medium in accordance with a method of manufacturing an information recording medium according to claim 1,
the information recording medium manufacturing apparatus comprising:
a heating device that heats the resin layer forming sheet;
a moving mechanism that moves at least one out of the resin layer forming sheet and the information recording medium substrate toward the another out of the resin layer forming sheet and the information recording medium substrate; and
a control unit that controls the heating device and the moving mechanism,
wherein the control unit controls the heating device to heat the resin layer forming sheet and controls the moving mechanism to move at least one out of the resin layer forming sheet and the information recording medium substrate toward the another out of the resin layer forming sheet and the information recording medium substrate and to press the one surface of the information recording medium substrate onto the adhesive layer so as to stick the information recording medium substrate and the resin layer forming sheet together and form the resin layer.
